(19) United States
(12) Patent Application Publication
(10) Pub. No.: US 2022/0145110 A1
(43) Pub. Date: May 12, 2022

(54) FLUID SETS FOR TEXTILE PRINTING

(71) Applicant: Hewlett-Packard Development Company, L.P., Spring, TX (US)

(72) Inventors: Dennis Z. Guo, San Diego, CA (US); Jie Zheng, San Diego, CA (US)

(73) Assignee: Hewlett-Packard Development Company, L.P., Spring, TX (US)

(21) Appl. No.: 17/417,411

(22) PCT Filed: Jul. 29, 2019
(86) PCT No.: PCT/US2019/043936

§ 371 Date: Jun. 23, 2021

(51) Int. Cl. C09D 11/40; C09D 11/322; C09D 11/102; C09D 11/033; C09D 11/037; C09D 11/54; D06P 5/30; D06P 5/00; D06P 1/52; B41M 5/00

(52) U.S. Cl. CPC C09D 11/40; C09D 11/322; C09D 11/102; C09D 11/033; C09D 11/037; C09D 11/54; D06P 3/60; D06P 5/002; D06P 1/5285; B41M 5/0047; B41M 5/0017; B41M 5/0023; D06P 5/30

(57) ABSTRACT

A fluid set for textile printing can include an ink composition including an ink vehicle, pigment, and from 1 wt % to 15 wt % epoxide-reactive polymer. The fluid set can also include a fixer fluid including a fixer vehicle, and from 0.5 wt % to 12 wt % of a multiepoxide-containing resin.

### BACKGROUND

Inkjet printing has become a popular way of recording images on various media. Some of the reasons include low printer noise, variable content recording, capability of high-speed recording, and multi-color recording. These advantages can be obtained at a relatively low price to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc.

### BRIEF DESCRIPTION OF THE DRAWINGS

FIG. 1 schematically represents an example fluid set for textile printing, including an ink composition and a fixer fluid, in accordance with the present disclosure;

FIG. 2 schematically depicts an example textile printing system that includes an ink composition, a fixer fluid, and a fabric substrate, in accordance with the present disclosure; and

FIG. 3 depicts an example method of printing in accordance with the present disclosure.

### DETAILED DESCRIPTION

In accordance with the present disclosure, a fluid set for textile printing includes an ink composition and a fixer fluid. The ink composition includes an ink vehicle, pigment, and from 1 wt % to 15 wt % epoxide-reactive polymer. The fixer fluid includes a fixer vehicle and from 0.5 wt % to 12 wt % of a multiepoxide-containing resin. In one example, the multiepoxide-containing resin can be an oligomer or polymer having the structure:

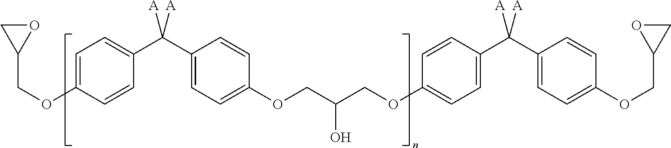

where n is from 0 to 30, from 0 to 10, from 1 to 30, from 5 to 30, or from 5 to 20; A is independently CₘH₂ₘ₊₁; and m is independently from 0 to 5, from 1 to 5, from 0 to 2, or from 2 to 5. In another example, the pigment can include a surface with an epoxide-reactive group. The epoxide-reactive polymer includes reactive groups selected from amine, carboxyl, hydroxyl, acid anhydride, phenol, thiol, or a combination thereof. The epoxide-reactive polymer can be a polyurethane binder. In one more specific example, the polyurethane binder can be an anionic aliphatic polyester-polyurethane. The fixer vehicle can include, for example, water and an organic co-solvent, the water being present in the fixer composition in an amount from 65 wt % to 96 wt % and the organic co-solvent being present in the fixer composition in an amount from 1.5 wt % to 32.5 wt %.

In another example, a textile printing system includes a fabric substrate, an ink composition, and a fixer fluid. The ink composition includes an ink vehicle, pigment, and from 1 wt % to 15 wt % epoxide-reactive polymer. The fixer fluid includes a fixer vehicle and from 0.5 wt % to 12 wt % of a multiepoxide-containing resin. In one example, the fabric substrate can include cotton, polyester, nylon, wool, or a blend thereof. The fabric substrate, for example, can include a surface with an epoxide-reactive group located to react with the multiepoxide-containing resin after contact therewith to affix the epoxide-reactive polymer to the fabric substrate through the multiepoxide-containing resin. The epoxide-reactive polymer can include reactive groups such as amine, hydroxyl, acid anhydride, phenol, thiol, or a combination thereof. The epoxide-reactive polymer can be a polyurethane binder with amine surface groups.

In another example, a method of printing includes jetting a fixer fluid onto a fabric substrate and jetting an ink composition onto the fabric substrate (in either order or simultaneously). The fixer fluid includes a fixer vehicle and from 0.5 wt % to 12 wt % of a multiepoxide-containing resin. The ink composition includes an ink vehicle, pigment, and from 1 wt % to 15 wt % epoxide-reactive polymer. The method further includes reacting the multiepoxide-containing resin with the epoxide reactive polymer on the fabric substrate. In one example, the multiepoxide-containing resin and the epoxide-reactive polymer can be jetted onto the fabric substrate at a resin to polymer weight ratio from 0.05:1 to 3:1. In further detail, reacting the multiepoxide-containing resin with the epoxide reactive polymer can include heating the fabric substrate having the fixer fluid and the ink composition in contact thereon to a temperature of from 80° C. to 200° C. for a period of from 5 seconds to 30 minutes.

In addition to the examples described above, the fluid sets, printing systems, and methods of printing will be described in greater detail below. It is also noted that when discussing the fluid sets, printing systems, and/or method of printing described herein, these relative discussions can be considered applicable to the other examples, whether or not they are explicitly discussed in the context of that example. Thus, for example, in discussing a fixer fluid related to a fluid set, such disclosure is also relevant to and directly supported in the context of the printing system and the methods of printing described herein, and vice versa.

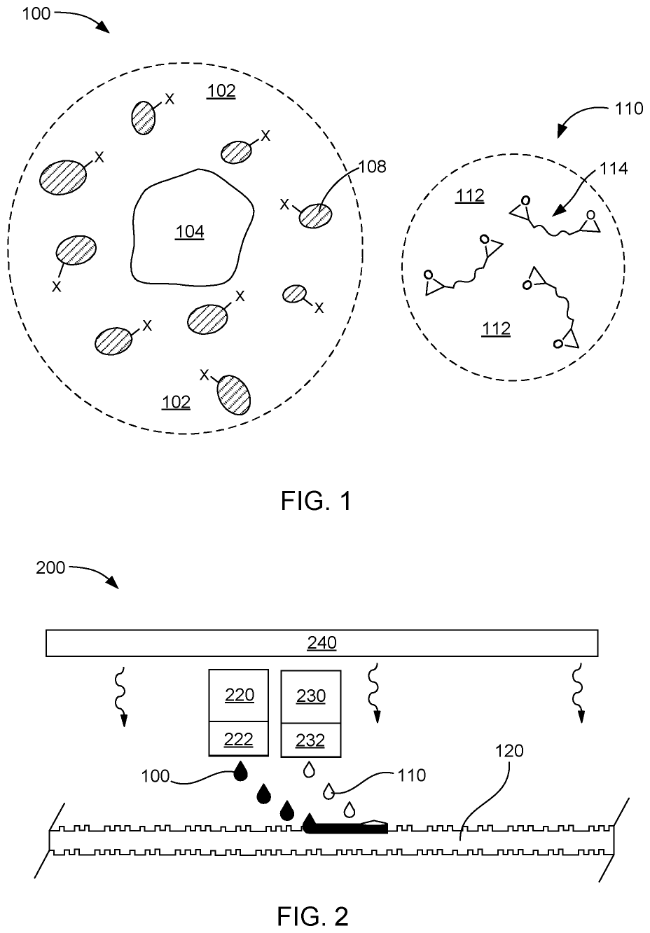

Turning now to FIG. 1, an ink composition 100 can include an ink vehicle 102 (which can include water and organic co-solvent, for example) and pigment 104 (or pigment particles or solids) dispersed therein. An epoxide-reactive polymer 108 can also be present. In this FIG., the epoxide-reactive polymer is shown having surface groups X that are reactive with epoxide groups. For example, X can represent amines, including amino groups or secondary or tertiary amine groups, acid anhydrides, phenols, hydroxyls, and/or thiols. The relative sizes of the pigment and the epoxide-reactive polymer are not drawn to scale. Furthermore, the pigment can further include a dispersing agent or dispersing polymer associated with a surface thereof (not shown), e.g., covalently attached as a part of a self-dispersed pigment, or ionically attracted to adsorb onto the pigment surface, etc.

The pigment 104 can be any of a number of pigment colorants of any of a number of primary or secondary colors, or can be black or white, for example. More specifically, if a color, the color may include cyan, magenta, yellow, red, blue, violet, orange, green, etc. In one example, the ink composition 100 can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, PO48, PO49, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., Pigment Yellow 74 and Pigment Yellow 155. In one example, the pigment can include aromatic moieties. In yet another example, the ink composition can be a white ink with a white pigment, e.g. titanium dioxide, talc, zinc oxide, zinc sulfide, lithopone, etc. The pigment may also include at its surface an epoxide-reactive group and/or the dispersant for the pigment may include an epoxide reactive group, for example.

With respect to the dispersing agent or dispersing polymer mentioned previously, in some examples, the pigment 104 can be dispersed by a polymer dispersant, such as a styrene (meth)acrylate dispersant, or another dispersant suitable for keeping the pigment suspended in the liquid vehicle 102. For example, the dispersant can be any dispersing (meth)acrylate polymer, or other type of polymer, such as a styrene maleic acid copolymer. In one specific example, the (meth)acrylate polymer can be a styrene-acrylic type dispersant polymer, as it can promote π-stacking between the aromatic ring of the dispersant and various types of pigments, such as copper phthalocyanine pigments, for example. Examples of commercially available styrene-acrylic dispersants can include Joncryl® 671, Joncryl® 71, Joncryl® 96, Joncryl® 680, Joncryl® 683, Joncryl® 678, Joncryl® 690, Joncryl® 296, Joncryl® 671, Joncryl® 696 or Joncryl® ECO 675 (all available from BASF Corp., Germany).

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). This can be the case for either dispersant polymer for pigment dispersion or for dispersed polymer binder that may include co-polymerized acrylate and/or methacrylate monomers. Also, in some examples, the terms “(meth)acrylate” and “(meth)acrylic acid” can be used interchangeably, as acrylates and methacrylates described herein include salts of acrylic acid and methacrylic acid, respectively. Thus, mention of one compound over another can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt form). Thus, a monomer or a moiety of a polymer described as (meth)acrylic acid or as (meth)acrylate should not be read so rigidly as to not consider relative pH levels, and other general organic chemistry concepts.

In further detail, the ink composition 100 can also include an epoxide-reactive polymer 108. A variety of epoxide-reactive polymers can be used. In one example, the epoxide-reactive polymer can be a polyurethane polymer, such as a polyester-polyurethane binder or other type of polyurethane. In some specific examples, the polyurethane binder can be a sulfonated polyurethane or a sulfonated polyester-polyurethane. In one example, the polyurethane binder can be anionic. In further detail, the polyurethane binder can be aliphatic including saturated carbon chains therein as part of the polymer backbone or sidechain thereof, e.g., C2 to C10, C3 to C8, or C3 to C6 alkyl. These polyurethane binders can be described as “alkyl” or “aliphatic” because these carbon chains are saturated and because they are devoid of aromatic moieties. An example polyurethane that includes several of these features is Impranil® DLN-SD (Mw 133,000 Mw; Acid Number 5.2; Glass Transition Temperature −47° C. Tg; Melting Point 175-200° C.) from Covestro (Germany), which is an anionic aliphatic polyester-containing polyurethane binder. Example components used to prepare the Impranil® DLN-SD or other similar anionic aliphatic polyester-polyurethane binders can include pentyl glycols, e.g., neopentyl glycol; C4-C10 alkyl diol, e.g., hexane-1,6-diol; C4 to C10 alkyl dicarboxylic acids, e.g., adipic acid; C4 to C10 alkyl diisocyanates, e.g., hexamethylene diisocyanate (HDI); diamine sulfonic acids, e.g., 2-[(2-aminoethyl)amino]-ethane sulfonic acid; etc. Alternatively, the polyurethane binder can be aromatic (or include an aromatic moiety) along with aliphatic chains. An example of an aromatic polyester-polyurethane binder that can be used is Dispercoll® U42. Example components used to prepare the Dispercoll® U42 or other similar aromatic polyester-polyurethane binders can include aromatic dicarboxylic acids, e.g., phthalic acid; C4 to C10 alkyl dialcohols, e.g., hexane-1,6-diol; C4 to C10 alkyl diisocyanates, e.g., hexamethylene diisocyanate (HDI); diamine sulfonic acids, e.g., 2-[(2-aminoethyl)amino]-ethane sulfonic acid; etc. Other types of polyester-polyurethanes can also be used, including Impranil® DL 1380, which can be somewhat more difficult to jet from thermal inkjet printheads compared to Impranil® DLN-SD and Dispercoll® U42, but still can be acceptably jetted in some examples, and can also provide acceptable washfastness results on a variety of fabric types.

Other example epoxide-reactive polymers that can be used include acrylate resins, vinyl acrylate resins, styrene acrylate resins, styrene butadiene resins, acrylonitrile resins, styrene butadiene resins, polyurethane acrylate hybrid resins, melamine resins and silicone resins.

The epoxide-reactive polymer can be present in the ink composition in an amount from 1 wt % to 15 wt %. In other examples, the epoxide-reactive polymer can be present in the ink composition in an amount from 2 wt % to 12 wt %. In yet other examples, the epoxide-reactive polymer can be present in the ink composition in an amount from 3 wt % to 10 wt %, or from 3 wt % to 8 wt %, for example. In still other examples, the epoxide-reactive polymer can be present in the ink composition in an amount from 4 wt % to 10 wt %.

Also shown in FIG. 1, the ink composition 100 of the present disclosure can be formulated to include an ink vehicle 102, which can include the water content, e.g., 60 wt % to 90 wt % or from 75 wt % to 85 wt %, as well as organic co-solvent, e.g., from 4 wt % to 30 wt %, from 6 wt % to 20 wt %, or from 8 wt % to 15 wt %. Other liquid vehicle components can also be included, such as surfactant, antibacterial agent, another colorant, etc. However, as part of the ink composition, pigment, polymer dispersant, and the epoxide-reactive polymer can be included or carried by the ink vehicle components.

In further detail regarding the ink vehicle 102, co-solvent(s) can be present and can include any co-solvent or combination of co-solvents that is compatible with the pigment, dispersant, epoxide-reactive polymer, etc. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, e.g., Dowanol™ TPM (from Dow Chemical, USA), higher homologs (C₅-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, dimethyl sulfoxide, sulfolane, glycol ethers, alkyldiols such as 1,2-hexanediol, and/or ethoxylated glycerols such as LEG-1, etc.

The ink vehicle can also include surfactant. In general, the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a Surfynol® surfactant, e.g., Surfynol® 440 (from Evonik, Germany), or a Tergitol™ surfactant, e.g., Tergitol™ TMN-6 (from Dow Chemical, USA). In another example, the surfactant can include an anionic surfactant, such as a phosphate ester of a C10 to C20 alcohol or a polyethylene glycol (3) oleyl mono/di phosphate, e.g., Crodafos® N3A (from Croda International PLC, United Kingdom). The surfactant or combinations of surfactants, if present, can be included in the ink composition at from 0.01 wt % to 5 wt % and, in some examples, can be present at from 0.05 wt % to 3 wt % of the ink compositions.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide®, e.g., Acticide® B20 (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents such as EDTA (ethylene diamine tetra acetic acid) may be included to eliminate the deleterious effects of heavy metal impurities, and buffer solutions may be used to control the pH of the ink. Viscosity modifiers and buffers may also be present, as well as other additives to modify properties of the ink as desired.

As also shown in FIG. 1, a fixer fluid 110 is included, which can contain a multiepoxide-containing resin 114 that is carried by a fixer vehicle 112 (which can include water and organic co-solvent, for example). In one example, the epoxide resin can include two or three epoxide groups, and thus can be or include a diglycidyl resin and/or triglycidyl resin. In other examples, there may be four or more epoxide groups present along a polymer chain. Notably, the ink vehicle in the ink composition and the fixer vehicle in the fixer fluid may or may not include the same liquid vehicle formulation, but in one example they are not the same. Regardless, whether the ink vehicle and the fixer vehicle are the same, they can in some examples include common ingredients, such as water, for example or other common organic co-solvents. Whether the same or different, both can also include an organic co-solvent. Thus, the discussion of the liquid vehicle described herein related to the ink composition is also relevant to the fixer vehicle of the fixer fluid, and the same types of liquid vehicle components can be independently selected for use therein.

In some specific examples, the fixer vehicle can include water and an organic co-solvent. Typically, water can be present in the fixer fluid in an amount from 65 wt % to 96 wt %. In other examples, water can be present in the fixer fluid in an amount from 70 wt % to 90 wt %. In still other examples, water can be present in the fixer fluid in an amount from 75 wt % to 85 wt %. Organic co-solvent can typically be present in the fixer fluid in an amount from 1.5 wt % to 34.5 wt %. In some examples, organic co-solvent can be present in the fixer fluid in an amount from 4 wt % to 20 wt %. In other examples, organic co-solvent can be present in the fixer fluid in an amount from 6 wt % to 16 wt %, or from 8 wt % to 14 wt %.

With specific reference to the multiepoxide-containing resin 114, FIG. 1 presents a representative simplified schematic formula for illustrative purposes only. The multiepoxide-containing resin selected for use can be any of a number of epoxide-containing resins with a plurality of epoxide groups. In an uncrosslinked state, as shown in Formula I below, a multiepoxide-containing resin generally has a structure as follows:

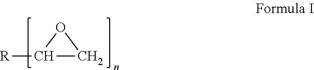

where n is from 2 to 20, from 2 to 10, from 4 to 20, or from 2 to 5; and R is representative of any of a number of polymer chains, including aliphatic moieties, e.g., straight, branched, or cyclic aliphatic groups, aromatic groups, heteroatoms, e.g., oxygen, sulfur, nitrogen, etc., hydroxyl groups, carboxyl groups, or any other group that does not cause the epoxide groups to open and prematurely react prior to contact with the ink compositions and/or fabric substrates described herein. The multiepoxide-containing resin, for example, can have a weight average molecular weight from 300 Mw to 30,000 Mw, from 320 Mw to 10,000 Mw, or from 340 Mw to 8,000 Mw. The multiepoxide-containing resin can be present in the fixer fluid at from 0.5 wt % to 12 wt %, from 1 wt % to 7 wt %, from 2 wt % to 6 wt %, from 3 wt % to 5 wt %, or from 3 wt % to 6 wt %, for example.

One example of a multiepoxide-containing resin that can be used in the fixer fluid is shown in Formula II, as follows:

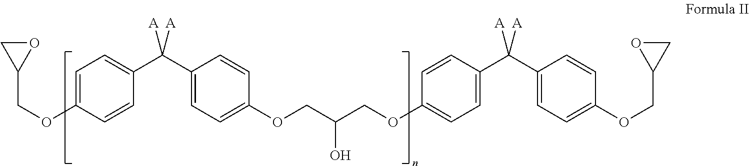

where n is from 0 to 30, from 0 to 20, from 0 to 10, from 1 to 30, from 5 to 30, or from 5 to 20; A is independently CₘH₂ₘ₊₁; and m is from 0 to 5, from 1 to 5, from 0 to 2, or from 2 to 5. This example is a diglycidyl ether of bisphenol A. An example commercially available diglycidyl ether of bisphenol A that can be used is Ancarez™ AR555 (CAS #25085-99-8) from Evonik (Germany).

With this in mind, it is noted that there are variations of the structure shown in Formula II that can be used, and thus, this structure is provided by way of example. For example, the compound may be monomethylated or may not include either methyl group between the aromatic rings. The compound may likewise include ethyl groups, and/or may include more ethers per repeating unit. Other example multiepoxide-containing resins that can be used include polyglycidyl ether of castor oil (cas #74398-71-3), tetraphenylolethane glycidyl ether (cas #7328-97-4), epoxy novolak resin, glycidylamine epoxy resin, aliphatic epoxy resin, e.g., straight-chained, branched, or cycloaliphatic, glycidyl ethers of aliphatic polyols, epoxy silane, etc.

Thus, when printing an ink composition containing an epoxide-reactive polymer in contact with a fixer fluid with a multiepoxide-containing resin, the epoxide-reactive polymer and the multiepoxide-containing resin can react and crosslink on the fabric substrate, for example. In some instances, as mentioned, the fabric substrate may also include epoxide-reactive groups that can also react with the multiepoxide-containing resin, thus allowing the epoxide-reactive polymer to become attached to the fabric substrate through a ring opening reaction with the multiepoxide-containing resin positioned therebetween in some instances. Example reactions between an epoxide group of a multiepoxide-containing resin (shown below at one location only) and an epoxide-reactive group from an epoxide-reactive polymer and/or from a fabric substrate are shown in Formulas III to VII, below:

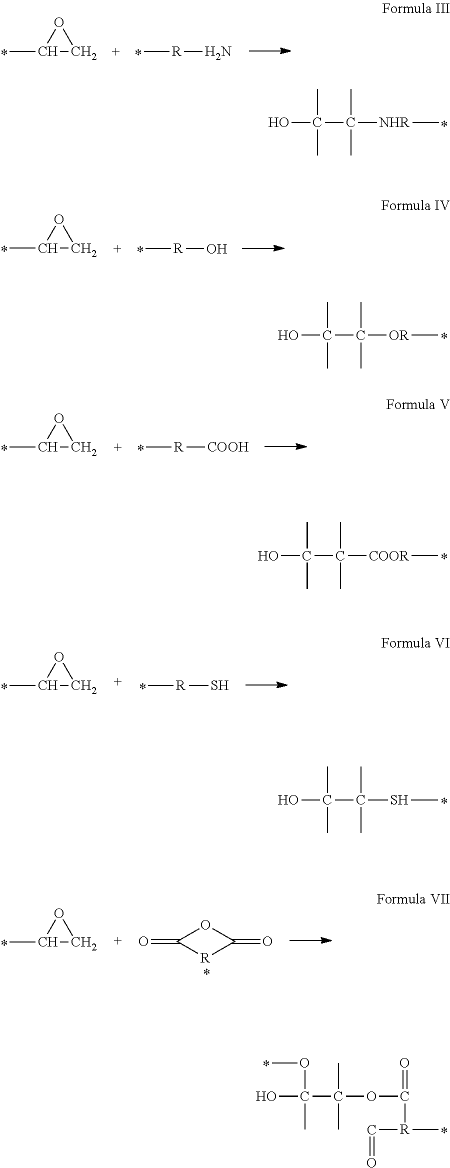

where R is representative of any of a number of polymer chains, including aliphatic moieties, e.g., straight, branched, or cyclic aliphatic groups, aromatic groups, heteroatoms, e.g., oxygen, sulfur, nitrogen, etc., hydroxyl groups, carboxyl groups, or any other group suitable for carrying the epoxide-reactive group thereon for reaction with the multiepoxide-containing resin from the fixer fluid after contact. The asterisks (*) independently represent a continuation of the polymer or oligomer beyond the functional groups shown, without limitation except to illustrate that the purpose of Formulas III and IV is to show how the functional groups of the various types of compounds may react upon contact with one another on a fabric substrate. In other words, the asterisks (*) represent portions of the various organic compounds that may not be directly part of the reaction shown in Formulas III and IV, and are thus not shown, but could be any of a number of organic groups or functional moieties, for example. Likewise, R can be H or include a number of organic groups as mentioned. It is also noted that other epoxide-reactive groups are not shown in Formulas III and IV, such as the acid anhydrides, phenols, thiols, secondary and tertiary amines, etc., and thus, those types of epoxide-reactive polymers or compounds including such epoxide-reactive groups can likewise be used.

As shown in FIG. 2, a textile printing system 200 is shown schematically and can include an ink composition 100 and a fixer fluid 110 for printing on a fabric substrate 120. In some examples, the textile printing system can further include various architectures related to ejecting fluids and treating fluids after ejecting onto the fabric substrate. For example, the ink composition can be printed from an inkjet pen 220 which includes an ejector 222, such as a thermal inkjet ejector or some other digital ejector technology. Likewise, the fixer fluid can be printed from a fluidjet pen 230 which includes an ejector 232, such as a thermal ejector or some other digital ejector technology, e.g., piezoelectric ejector. The inkjet pen and the fluidjet pen can be the same type of ejector or can be two different types of ejectors. Both may be thermal inkjet ejectors, for example. Also shown, as can be included in one example, is a heating device 240 to apply heat to the fabric substrate to cure the ink composition, e.g., causing a crosslinking reaction to occur or accelerate.

In some examples, when the fixer fluid is printed on the fabric substrate, there may be epoxide-reactive groups at the surface thereof, e.g., hydroxyl groups for cotton, amine groups for nylon, thiol groups for wool, or other suitable reactive groups in addition to the epoxide-reactive polymer that can be present in the ink composition. In such instances, the multiepoxide-containing resin can be used to crosslink the epoxide-reactive polymer or other components in the ink composition with the fabric substrate. Such an interaction can generate a high-quality image that exhibits durable washfastness as demonstrated in the examples hereinafter.

In further detail, the ink compositions 100 and the fixer fluids 110 may be suitable for printing on many types of fabric substrates 120, such as textiles and/or fabric, etc. Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the fabric substrates can include polymeric fibers such as, nylon fibers, polyvinyl chloride (PVC) fibers, PVC-free fibers made of polyester, polyamide, polyimide, polyacrylic, polypropylene, polyethylene, polyurethane, polystyrene, polyaramid (e.g., Kevlar®) polytetrafluoroethylene (Teflon®) (both trademarks of E. I. du Pont de Nemours Company, Delaware), fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, a copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

The fabric substrate can be in one of many different forms, including, for example, a textile, a cloth, a fabric material, fabric clothing, or other fabric product suitable for applying ink, and the fabric substrate can have any of a number of fabric structures. The term “fabric structure” is intended to include structures that can have warp and weft, and/or can be woven, non-woven, knitted, tufted, crocheted, knotted, and pressured, for example. The terms “warp” and “weft” have their ordinary meaning in the textile arts, as used herein, e.g., warp refers to lengthwise or longitudinal yarns on a loom, while weft refers to crosswise or transverse yarns on a loom.

It is notable that the term “fabric substrate” does not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into a finished article (e.g. clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of 90°. This woven fabric can include but is not limited to, fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of two or more of these processes.

As previously mentioned, the fabric substrate can be a combination of fiber types, e.g. a combination of any natural fiber with another natural fiber, any natural fiber with a synthetic fiber, a synthetic fiber with another synthetic fiber, or mixtures of multiple types of natural fibers and/or synthetic fibers in any of the above combinations. In some examples, the fabric substrate can include natural fiber and synthetic fiber. The amount of various fiber types can vary. For example, the amount of the natural fiber can vary from 5 wt % to 95 wt % and the amount of synthetic fiber can range from 5 wt % to 95 wt %. In yet another example, the amount of the natural fiber can vary from 10 wt % to 80 wt % and the synthetic fiber can be present from 20 wt % to 90 wt %. In other examples, the amount of the natural fiber can be 10 wt % to 90 wt % and the amount of synthetic fiber can also be 10 wt % to 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

In one example, the fabric substrate can have a basis weight ranging from 10 grams per square meter (gsm) to 500 gsm. In another example, the fabric substrate can have a basis weight ranging from 50 gsm to 400 gsm. In other examples, the fabric substrate can have a basis weight ranging from 100 gsm to 300 gsm, from 75 gsm to 250 gsm, from 125 gsm to 300 gsm, or from 150 gsm to 350 gsm.

In addition, the fabric substrate can contain additives including, but not limited to, colorant (e.g., pigments, dyes, and tints), antistatic agents, brightening agents, nucleating agents, antioxidants, UV stabilizers, fillers and lubricants, for example. Alternatively, the fabric substrate may be pre-treated in a solution containing the substances listed above before applying other treatments or coating layers.

Regardless of the fabric substrate used, whether natural fabric, synthetic fabric, fabric blend, treated, untreated, etc., the fabric substrates printed with the fluid sets of the present disclosure can provide acceptable optical density (OD) and/or washfastness properties. The term “washfastness” can be defined as the OD and or L*a*b* color space that are retained after five (5) standard washing machine cycles using warm water and a standard clothing detergent (e.g., Tide® available from Proctor and Gamble, Cincinnati, Ohio, USA). Essentially, by measuring OD and/or L*a*b* both before and after washing, %ΔOD decrease and ΔE value can be determined, which is essentially a quantitative way of expressing the difference between the OD and/or L*a*b* prior to and after undergoing the washing cycles. Thus, the lower the %ΔOD decrease and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The 1976 standard can be referred to herein as “ΔE_{CIE}.” The CIE definition was modified in 1994 to address some perceptual non-uniformities, retaining the L*a*b* color space, but modifying to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (R_{T}) to deal with the problematic blue region at hue angles of 275°), ii) compensation for neutral colors or the primed values in the L*C*h differences, iii) compensation for lightness (S_{L}), iv) compensation for chroma (S_{C}), and v) compensation for hue (S_{H}). The 2000 modification can be referred to herein as “ΔE₂₀₀₀.” In accordance with examples of the present disclosure, ΔE value can be determined using the CIE definition established in 1976, 1994, and 2000 to demonstrate washfastness. However, in the examples of the present disclosure, ΔE_{CIE} and ΔE₂₀₀₀ are used. Further, in 1984, a difference measurement, based on a L*C*h model was defined and called CMC l:c. This metric has two parameters: lightness (l) and chroma (c), allowing users to weight the difference based on the ratio of l:c that is deemed appropriate for the application. Commonly used values include 2:1 for acceptability and 1:1 for threshold of imperceptibility. This difference metric is also reported in various examples of the present disclosure.

In further detail, the textile printing system 200 can include a fixer fluid 110, which can include a multiepoxide-containing resin in a fixer vehicle, as previously described in relation to FIG. 1. The fixer fluid can be printed from a fluidjet pen 230 which includes an ejector 232, such as a fluid ejector which can also be a thermal inkjet ejector. In one example, epoxide groups of the fixer fluid can interact with the epoxide-reactive polymer (of the ink composition 100), the fabric substrate 120, or both to form a covalent linkage therewith. In other examples, the multi-epoxide-containing resin may not attach to the fabric substrate, crosslinking with ink composition components, e.g., epoxide-reactive polymer, pigment, etc., but not the fabric substrate. Even without attaching to the fabric substrate per se, washfastness durability, enhanced optical density, and other properties can be achieved with respect to the ink composition printed on the fabric substrate. In some examples, a curing device 240 can be used to apply heat to the fabric substrate to cure the ink composition, e.g., causing the crosslinking reaction to occur or accelerate. Heat can be applied using forced hot air, a heating lamp, an oven, or the like. Curing the ink composition contacted with the fixer fluid on the fabric substrate can occur at a temperature from 80° C. to 200° C. for from 5 seconds to 30 minutes, from 100° C. to 180° C. for from 10 seconds to 10 minutes, from 130° C. to 180° C. for from 30 seconds to 4 minutes, or any combination of these ranges and time frames thereof.

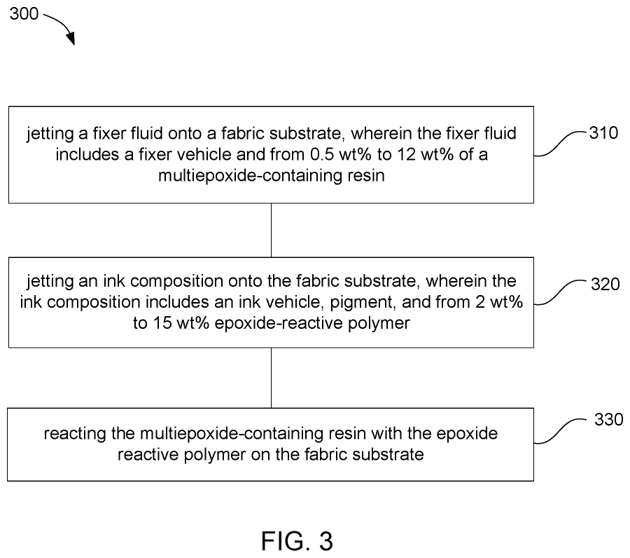

In another example, and as set forth in FIG. 3, a method 300 of printing can include jetting 310 a fixer fluid onto a fabric substrate, wherein the fixer fluid includes a fixer vehicle and from 0.5 wt % to 12 wt % of a multiepoxide-containing resin, and jetting 320 an ink composition onto the fabric substrate, wherein the ink composition includes an ink vehicle, pigment, and from 2 wt % to 15 wt % epoxide-reactive polymer. The method can further include reacting 330 the multiepoxide-containing resin with the epoxide reactive polymer on the fabric substrate. In one example, the multiepoxide-containing resin and the epoxide-reactive polymer can be jetted onto the fabric substrate at a resin to polymer weight ratio from 0.05:1 to 3:1, from 0.1:1 to 2:1, or from 0.2:1 to 1.5:1. For purposes of good jettability, particularly with thermal inkjet technology, in one example, the fixer fluid can have a surface tension of from 21 dyne/cm to 55 dyne/cm at 25° C. and a viscosity of from 1 centipoise (cP) to 15 cP at 25° C., though surface tensions outside of this range can be used for some types of ejector technology, e.g., piezoelectric ejector technology. Surface tension can be measured by the Wilhelmy plate method with a Kruss tensiometer. It is also noted that the method of printing can also include heating the fixer fluid and the ink composition to a temperature from 80° C. to 200° C. for a period of from 5 seconds to 10 minutes, or other suitable temperature and timeframe as disclosed herein. Suitable heating devices can include heating lamps, curing ovens, forced air drying devices, or the like that apply heated air to the media substrate.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those in the field technology to determine based on experience and the associated description herein.

As used herein, a plurality of items, structural elements, compositional elements, and/or materials may be presented in a common list for convenience. However, these lists should be construed as though individual member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also all the individual numerical values or sub-ranges encompassed within that range as if individual numerical values and sub-ranges are explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following are only exemplary or illustrative of the application of the principles of the presented fabric print media and associated methods. Numerous modifications and alternatives may be devised without departing from the present disclosure. The appended claims are intended to cover such modifications and arrangements. Thus, while the disclosure has been provided with particularity, the following illustrates further detail in connection with what are presently deemed to be the acceptable examples.

### Example 1—Preparation of Ink Compositions

An ink set was prepared as shown in Table 1 below. Specifically, a Black (K) Ink, a Cyan (C) Ink, a Magenta (M) Ink, and a Yellow (Y) Ink were prepared with Impranil® DLN-SD polyurethane binder, which is an anionic aliphatic polyester-polyurethane binder, as follows:

TABLE 1
K, C, M, Y Ink Compositions with Impranil ® DLN-SD

| | | Black Ink | Cyan Ink | Magenta Ink | Yellow Ink |
|---|---|---|---|---|---|
| | | (K) | (C) | (M) | (Y) |
| Ink ID | Category | Wt % | Wt % | Wt % | Wt % |
| Black Pigment | Pigment Dispersion | 2.5 | — | — | — |
| Cyan Pigment | Pigment Dispersion | — | 2.5 | — | — |
| Magenta Pigment | Pigment Dispersion | — | — | 3.0 | — |
| Yellow Pigment | Pigment Dispersion | — | — | — | 3.0 |
| Impranil ® DLN- | Polyurethane binder | 6 | 6 | 6 | 6 |
| SD | | | | | |
| Glycerol | Organic Cosolvent | 8 | 8 | 8 | 8 |
| LEG-1 | Organic Cosolvent | 1 | 1 | 1 | 1 |
| Crodafos ™ N3A | Surfactant | 0.5 | 0.5 | 0.5 | 0.5 |
| Surfynol ® 440 | Surfactant | 0.3 | 0.3 | 0.3 | 0.3 |
| Acticide ® B20 | Biocide | 0.22 | 0.22 | 0.22 | 0.22 |
| Deionized Water | Water | Balance | Balance | Balance | Balance |

Impranil ® is available from Covestro (USA)
Crodafos ™ is avaiable from Croda ® International Plc. (Great Britain).
Surfynol ® is available from Evonik, (Germany).
Acticide ® is available from Thor Specialties, Inc. (USA).

### Example 2—Preparation of Fixer Fluids

Two fixer fluids including a cationic fixing agent including a multiepoxide-containing resin was prepared according to Table 2, as follows:

TABLE 2
Fixer Fluids with Waterborne Multiepoxide-containing Resin

| | | Fixer 1 | Fixer 2 |
|---|---|---|---|
| Component | Category | Amount (Wt %) | Amount (Wt %) |
| 2-Pyrrolidone | Organic Cosolvent | 10 | 10 |
| Ancarez AR555 | Multiepoxide- | 6 | 9 |
| | containing Resin | | |
| BYK-348 | Surfactant | 0.1 | 0.1 |
| Water | Solvent | Balance | Balance |

Ancarez ™AR555 is available from Air Products (USA); BYK-348 is available from BYK Additives and Instruments (Germany)

### Example 3—Stability of Fixer Fluids

To evaluate stability, Fixer-1 and Fixer-2 were tested initially for pH and viscosity (cP), and then subjected to accelerated shelf-life (ASL) conditions to see how much these parameters changed. The ASL stress was at 60° C. for 1 week. Following the elevated temperature storage period, the samples were allowed to equilibrate to room temperature and retested. The data collected is in Table 3 below, as follows:

TABLE 3
Fixer Fluid Accelerated Shelf-life

| Fixer | pH (Initial) | pH (ASL) | Viscosity (Initial cP) | Viscosity (ASL cP) |
|---|---|---|---|---|
| Fixer-1 | 7.42 | 7.67 | 1.2 | 1.2 |
| Fixer-2 | 7.54 | 7.63 | 1.4 | 1.4 |

### Example 4—Washfastness for Ink Compositions Using Fixer with Multiepoxide-Containing Resin

The Ink Compositions of Example 1 (K, C, M, and Y) were applied at 3 drops per pixel (dpp) at 12 ng per drop (20 gsm) onto 100% cotton and 50/50 (w/w) cotton/polyester blend fabric substrates, both without application of a fixer fluid and with two different volumes of fixer fluid. When used, the fixer fluids were applied in direct contact with the ink compositions at either 1.5 dpp or 3 dpp. Samples were cured at 150° C. for 3 minutes. Printed samples were washed 5 times with Sears Kenmore 90 Series Washer (Model 110.289 227 91) and warm water (about 40° C.) with detergent and air drying between washes. The samples were measured for OD and L*a*b* before and after the 5 washes. After the five cycles, optical density (OD) and L*a*b* values were measured for comparison, and delta E (ΔE) values were calculated using the 1976 standard denoted as ΔE_{CIE} as well as the 2000 standard denoted as ΔE₂₀₀₀. ΔE_{CMC} (2:1) values are also reported. Results are depicted in Tables 4A and 4B, as follows:

TABLE 4A
100% Cotton Fabric Substrate

| Ink | Fixer | | | % | | | |
|---|---|---|---|---|---|---|---|
| (all at | (None, 1.5, | OD | OD | ΔOD | | | ΔE_{CMC} |
| 3 dpp) | or 3 dpp) | (Prewash) | (5 washes) | decrease | ΔE_{CIE} | ΔE₂₀₀₀ | (2:1) |
| K | None | 1.148 | 0.946 | 17.6 | 9.44 | 8.05 | 7.53 |
| C | None | 1.125 | 0.949 | 15.7 | 6.12 | 4.61 | 2.90 |
| M | None | 1.004 | 0.870 | 13.3 | 6.75 | 3.35 | 2.79 |
| Y | None | 1.078 | 0.829 | 23.1 | 13.89 | 3.03 | 4.30 |
| K | Fixer 1 (1.5) | 1.088 | 0.925 | 15.0 | 7.30 | 6.36 | 6.05 |
| C | Fixer 1 (1.5) | 1.041 | 0.914 | 12.2 | 4.24 | 3.07 | 2.16 |
| M | Fixer 1 (1.5) | 0.933 | 0.839 | 10.1 | 5.37 | 2.61 | 2.31 |
| Y | Fixer 1 (1.5) | 1.003 | 0.804 | 19.9 | 11.11 | 2.49 | 3.51 |
| K | Fixer 2 (1.5) | 1.135 | 0.928 | 18.2 | 8.84 | 7.59 | 7.43 |
| C | Fixer 2 (1.5) | 1.044 | 0.938 | 10.2 | 4.24 | 3.02 | 2.16 |
| M | Fixer 2 (1.5) | 0.927 | 0.833 | 10.1 | 5.18 | 2.53 | 2.24 |
| Y | Fixer 2 (1.5) | 0.993 | 0.828 | 16.6 | 9.66 | 2.15 | 3.05 |
| K | Fixer 1 (3) | 1.094 | 0.931 | 14.9 | 7.84 | 6.85 | 6.61 |
| C | Fixer 1 (3) | 1.057 | 0.918 | 13.2 | 5.39 | 3.89 | 2.63 |
| M | Fixer 1 (3) | 0.923 | 0.825 | 10.6 | 5.63 | 2.74 | 2.42 |
| Y | Fixer 1 (3) | 1.004 | 0.824 | 18.0 | 9.53 | 2.12 | 3.01 |
| K | Fixer 2 (3) | 1.090 | 0.967 | 11.2 | 6.08 | 5.33 | 5.48 |
| C | Fixer 2 (3) | 1.085 | 0.975 | 10.1 | 3.25 | 2.17 | 1.78 |
| M | Fixer 2 (3) | 0.961 | 0.866 | 9.9 | 5.41 | 2.51 | 2.30 |
| Y | Fixer 2 (3) | 1.003 | 0.858 | 14.4 | 8.62 | 1.89 | 2.71 |

TABLE 4B
50/50 (w/w) Cotton/Polyester Fabric Substrate

| Ink | Fixer | | | % | | | |
|---|---|---|---|---|---|---|---|
| (all at | (None, 1.5, | OD | OD | ΔOD | | | ΔE_{CMC} |
| 3 dpp) | or 3 dpp) | (Prewash) | (5 washes) | decrease | ΔE_{CIE} | ΔE₂₀₀₀ | (2:1) |
| K | None | 1.162 | 0.947 | 18.5 | 9.00 | 7.54 | 6.10 |
| C | None | 1.149 | 0.940 | 18.2 | 6.88 | 5.16 | 2.98 |
| M | None | 1.051 | 0.884 | 15.9 | 8.56 | 4.29 | 3.32 |
| Y | None | 1.066 | 0.857 | 19.6 | 12.36 | 2.70 | 3.83 |
| K | Fixer 1 (1.5) | 1.135 | 1.008 | 11.2 | 5.81 | 4.81 | 3.81 |
| C | Fixer 1 (1.5) | 1.099 | 0.980 | 10.8 | 3.62 | 2.62 | 1.57 |
| M | Fixer 1 (1.5) | 1.013 | 0.917 | 9.5 | 4.22 | 2.04 | 1.71 |
| Y | Fixer 1 (1.5) | 1.043 | 0.917 | 12.0 | 6.55 | 1.45 | 2.07 |
| K | Fixer 2 (1.5) | 1.127 | 1.028 | 8.8 | 4.69 | 3.87 | 3.18 |
| C | Fixer 2 (1.5) | 1.103 | 1.030 | 6.6 | 3.30 | 2.22 | 1.38 |
| M | Fixer 2 (1.5) | 1.002 | 0.936 | 6.6 | 3.80 | 1.77 | 1.51 |
| Y | Fixer 2 (1.5) | 1.023 | 0.931 | 8.9 | 5.08 | 1.13 | 1.61 |
| K | Fixer 1 (3) | 1.142 | 0.988 | 13.4 | 5.63 | 4.68 | 3.70 |
| C | Fixer 1 (3) | 1.067 | 0.972 | 9.0 | 3.14 | 2.15 | 1.33 |
| M | Fixer 1 (3) | 1.009 | 0.909 | 9.9 | 4.67 | 2.11 | 1.80 |
| Y | Fixer 1 (3) | 1.021 | 0.903 | 11.6 | 6.12 | 1.39 | 1.95 |
| K | Fixer 2 (3) | 1.123 | 1.027 | 8.5 | 3.71 | 3.08 | 2.51 |
| C | Fixer 2 (3) | 1.090 | 1.030 | 5.5 | 1.82 | 1.18 | 0.77 |
| M | Fixer 2 (3) | 1.000 | 0.927 | 7.3 | 3.10 | 1.32 | 1.23 |
| Y | Fixer 2 (3) | 1.004 | 0.948 | 5.6 | 3.21 | 0.79 | 1.04 |

As can be seen in the data presented in Tables 4A and 4B, acceptable washfastness for individual ink compositions printed in combination with fixer fluid occurred in many instances, particularly relative to most combinations without the fixer fluid. For example, OD was better in 3 of 4 instances with black (K) relative to the use of no fixer fluid, and the three ink colors (CMY) all improved compared to the use of no fixer fluid. Likewise, with respect to ΔE across the board, in every instance, there was an improvement compared to the use of no fixer fluid. This data was verified by comparing pre-wash optical density (OD) with post-wash OD and ΔE_{CIE}, ΔE₂₀₀₀, or ΔE_{CMC} (2:1) calculated from pre- and post-wash L*a*b* values.

While the present technology has been described with reference to certain examples, various modifications, changes, omissions, and substitutions can be made without departing from the spirit of the disclosure. It is intended, therefore, that the disclosure be limited only by the scope of the following claims.

What is claimed is:

1. A fluid set for textile printing, comprising:
an ink composition including:
an ink vehicle,
pigment, and
from 1 wt % to 15 wt % epoxide-reactive polymer; and
a fixer fluid including:
a fixer vehicle, and
from 0.5 wt % to 12 wt % of a multiepoxide-containing resin.

2. The fluid set of claim 1, wherein the multiepoxide-containing resin is an oligomer or polymer having the structure: 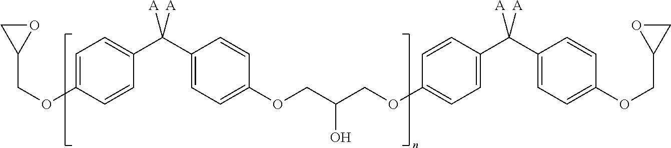
where n is from 0 to 30, A is independently CₘH₂ₘ₊₁, and m is from 0 to 5.

3. The fluid set of claim 1, wherein the pigment includes a surface with an epoxide-reactive group.

4. The fluid set of claim 1, wherein the epoxide-reactive polymer includes reactive groups selected from amine, carboxyl, hydroxyl, acid anhydride, phenol, thiol, or a combination thereof.

5. The fluid set of claim 1, wherein the epoxide-reactive polymer is a polyurethane binder.

6. The fluid set of claim 5, wherein the polyurethane binder is an anionic aliphatic polyester-polyurethane.

7. The fluid set of claim 1, wherein the fixer vehicle comprises water and an organic co-solvent, the water being present in the fixer composition in an amount from 65 wt % to 96 wt % and the organic co-solvent being present in the fixer composition in an amount from 1.5 wt % to 32.5 wt %.

8. A textile printing system, comprising:
a fabric substrate;
an ink composition including:
an ink vehicle,
pigment, and
from 1 wt % to 15 wt % epoxide-reactive polymer; and
a fixer fluid including:
a fixer vehicle, and
from 0.5 wt % to 12 wt % of a multiepoxide-containing resin.

9. The textile printing system of claim 8, wherein the fabric substrate includes cotton, polyester, nylon, wool, or a blend thereof.

10. The textile printing system of claim 8, wherein the fabric substrate includes a surface with an epoxide-reactive groups located to react with the multiepoxide-containing resin after contact therewith to affix the epoxide-reactive polymer to the fabric substrate through the multiepoxide-containing resin.

11. The textile printing system of claim 8, wherein the epoxide-reactive polymer includes reactive groups selected from amine, hydroxyl, acid anhydride, phenol, thiol, or a combination thereof.

12. The textile printing system of claim 8, wherein the epoxide-reactive polymer is a polyurethane binder with amine surface groups.

13. A method of printing, comprising:
jetting a fixer fluid onto a fabric substrate, wherein the fixer fluid includes a fixer vehicle and from 0.5 wt % to 12 wt % of a multiepoxide-containing resin;
jetting an ink composition onto the fabric substrate, wherein the ink composition includes an ink vehicle, pigment, and from 1 wt % to 15 wt % epoxide-reactive polymer; and
reacting the multiepoxide-containing resin with the epoxide reactive polymer on the fabric substrate.

14. The method of claim 13, wherein the multiepoxide-containing resin and the epoxide-reactive polymer are jetted onto the print media substrate at a resin to polymer weight ratio from 0.05:1 to 3:1.

15. The method of claim 13, wherein reacting includes heating the fabric substrate having the fixer fluid and the ink composition in contact thereon to a temperature of from 80° C. to 200° C. for a period of from 5 seconds to 30 minutes.
